(19) United States
(12) Patent Application Publication
(10) Pub. No.: US 2016/0222617 A1
(43) Pub. Date: Aug. 4, 2016

(54) TRACTION CONTROL AGENT FREEZE PREVENTER

(71) Applicant: Gary Fydenkevez, Hadley, MA (US)

(72) Inventor: Gary Fydenkevez, Hadley, MA (US)

(21) Appl. No.: 15/013,371

(22) Filed: Feb. 2, 2016

Related U.S. Application Data
(60) Provisional application No. 62/111,909, filed on Feb. 4, 2015.

(51) Int. Cl. E01H 10/00; H05B 3/36; H05B 1/02

(52) U.S. Cl. CPC E01H 10/007; H05B 1/02; H05B 3/36

(57) ABSTRACT

A traction control agent freeze preventer including: a base including a metal; a cover, which is disposed on the base, wherein the cover includes a flange disposed adjacent to the base and on a perimeter of the cover; a heating pad disposed adjacent to the base and between the cover and the base; an insulation layer disposed between the heating pad and the cover and opposite the base, wherein the insulation layer and the heating pad are entirely contained between the base and the cover; and a temperature controller, which is connected to the heating pad and configured to control a temperature of the heating pad.

### CROSS REFERENCE TO RELATED APPLICATION

This application claims priority to U.S. Provisional Patent Application No. 62/111,909, filed on Feb. 4, 2015, and all the benefits accruing therefrom under 35 U.S.C. §119, the content of which is incorporated herein by reference in its entirety.

### BACKGROUND

(1) Field

This disclosure relates to a traction control agent freeze preventer and to a method of preventing the traction control agent from freezing prior to its distribution.

(2) Description of the Related Art

A traction control agent, such as salt, sand, gravel, or a chemical de-icer is often used for deicing, anti-icing, and enhancing traction on roads and walkways. To facilitate distribution of the traction control agent on the road or walkway, the traction control agent may be held within a hopper, which in turn is on a vehicle, and the traction control agent distributed by a spreader while the vehicle is in motion. However, due at least in part to the wet weather conditions in which they are often used, water in the traction control agent can freeze, which makes spreading the traction control agent difficult. Therefore there remains a need for a method to prevent freezing of the traction control agent when it is disposed in a hopper and prior to its distribution on the road or walkway.

### SUMMARY

Disclosed is a traction control agent freeze preventer including: a base including a metal; a cover, which is disposed on the base, wherein the cover includes a flange disposed adjacent to the base and on a perimeter of the cover; a heating pad disposed adjacent to the base and between the cover and the base; an insulation layer disposed between the heating pad and the cover and opposite the base, wherein the insulation layer and the heating pad are entirely contained between the base and the cover; and a temperature controller, which is connected to the heating pad and configured to control a temperature of the heating pad.

Also disclosed is a traction control agent dispenser including: a hopper; and a traction control agent freeze preventer on the hopper; the traction control agent freeze preventer including a metal; a cover, which is disposed on the base, wherein the cover includes a flange disposed adjacent to the base and on a perimeter of the cover; a heating pad disposed adjacent to the base and between the cover and the base; an insulation layer disposed between the heating pad and the cover and opposite the base, wherein the insulation layer and the heating pad are entirely contained between the base and the cover; and a temperature controller, which is connected to the heating pad and configured to control a temperature of the heating pad.

Also disclosed is a road maintenance vehicle including a vehicle and the traction control agent dispenser disposed on the vehicle.

Also disclosed is a method of treating a traction control agent, the method including disposing a traction control agent into a traction control agent dispenser; and actuating a traction control agent freeze preventer to heat the traction control agent to treat the traction control agent; the traction control agent dispenser including: a hopper, and a traction control agent freeze preventer on the hopper, the traction control agent freeze preventer including a metal, a cover, which is disposed on the base, wherein the cover includes a flange disposed adjacent to the base and on a perimeter of the cover, a heating pad disposed adjacent to the base and between the cover and the base, an insulation layer disposed between the heating pad and the cover and opposite the base, wherein the insulation layer and the heating pad are entirely contained between the base and the cover, and a temperature controller, which is connected to the heating pad and configured to control a temperature of the heating pad.

Also disclosed is a method of road maintenance, the method including: providing a vehicle including a traction control agent dispenser, the traction control agent dispenser including: a hopper; and a traction control agent freeze preventer on the hopper, the traction control agent freeze preventer including a metal, a cover, which is disposed on the base, wherein the cover includes a flange disposed adjacent to the base and on a perimeter of the cover, a heating pad disposed adjacent to the base and between the cover and the base, an insulation layer disposed between the heating pad and the cover and opposite the base, wherein the insulation layer and the heating pad are entirely contained between the base and the cover; and a temperature controller, which is connected to the heating pad and configured to control a temperature of the heating pad; disposing a traction control agent in the traction control agent dispenser; actuating the traction control agent freeze preventer to heat the traction control agent; and dispensing the traction control agent to perform road maintenance.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is an isometric view of an embodiment of the traction control agent freeze preventer;

FIG. 2 is a side view of the traction control agent freeze preventer shown in FIG. 1;

FIG. 3 is a cross-sectional view of the traction control agent freeze preventer shown in FIG. 1;

FIG. 4 is a top view of the traction control agent freeze preventer shown in FIG. 1;

FIG. 5 is a cross-sectional plan view of an embodiment of a base of the traction control agent freeze preventer;

FIG. 6 shows an embodiment of the traction control agent freeze preventer mounted on an underside of a hopper; and

FIG. 7 shows an embodiment of the traction control agent freeze preventer mounted on an underside of a hopper which is disposed on a vehicle.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

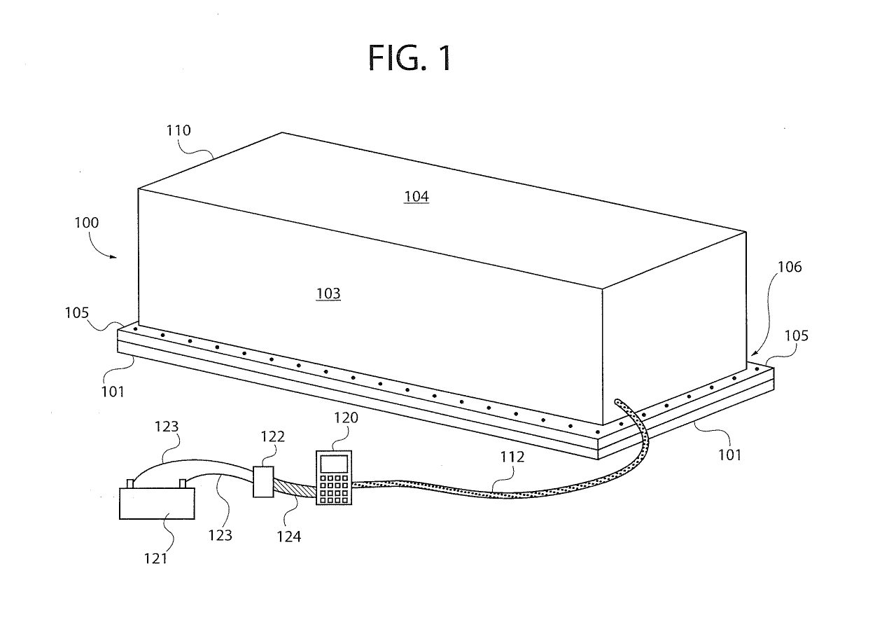

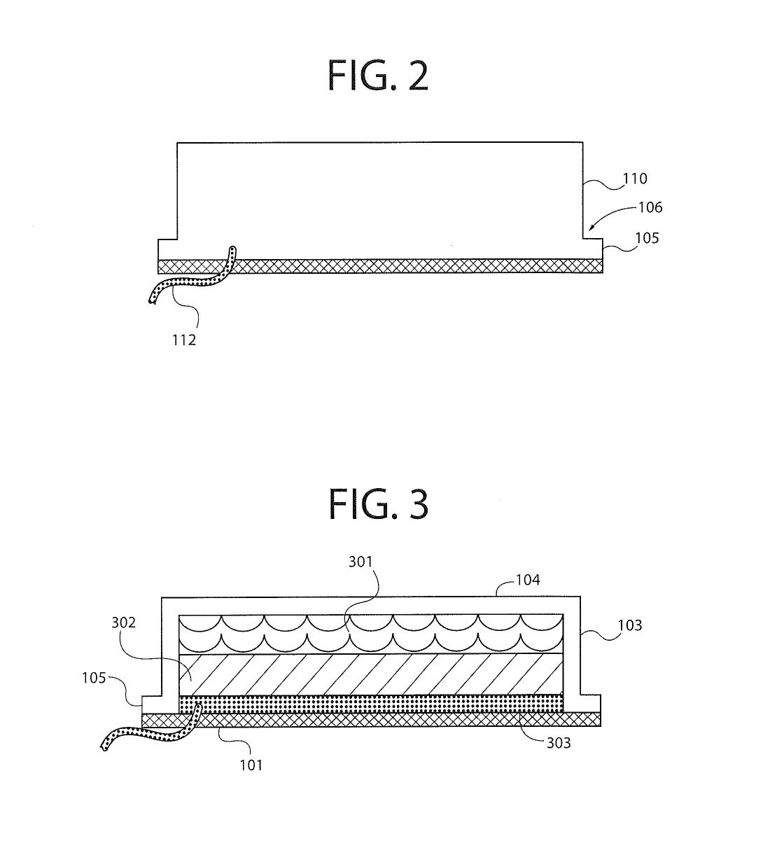

Disclosed is a traction control agent freeze preventer 100 comprising: a base 101 comprising a metal, a cover 110 which is disposed on a top surface of the base, wherein the cover comprises a flange 105, which is disposed adjacent to the base and on a perimeter 106 of the cover 110; a heating pad 303 disposed adjacent to the base and between the cover and the base; an insulation layer disposed between the heating pad and the cover and opposite the base, wherein the insulation layer and the heating pad are entirely contained between the base and the cover; and a temperature controller, which is connected to the heating pad and configured to control a temperature of the heating pad. An isometric view of an embodiment of the traction control agent freeze preventer 100 is shown in FIG. 1. A side view of an embodiment of the traction control agent freeze preventer 100 is shown in FIG. 2.

The term traction control agent, as used herein, shall refer to any suitable de-icing or friction enhancing substance, such as salt, sand, gravel or a combination thereof. Representative traction control agents include play sand, rock salt, sodium chloride, calcium chloride, magnesium chloride, or combination thereof. Commercially available materials include Ice Melt, Ice-A-Way, and Snow Joe Melt, each of which is commercially available.

The base 101 may have any suitable dimensions, and may comprise any suitable metal. Representative metals for the base include steel, aluminum, iron, copper, tin, or combination thereof. Aluminum is specifically mentioned. In an embodiment, the metal has a thermal conductivity of 15 Watts per meter per Kelvin to 251 Watts per meter per Kelvin. In an embodiment the base 101 is rectilinear, as shown in FIG. 1. A length of the base may be 1 meter (m) to 10 m, and a width of the base may be 0.5 m to 5 m.

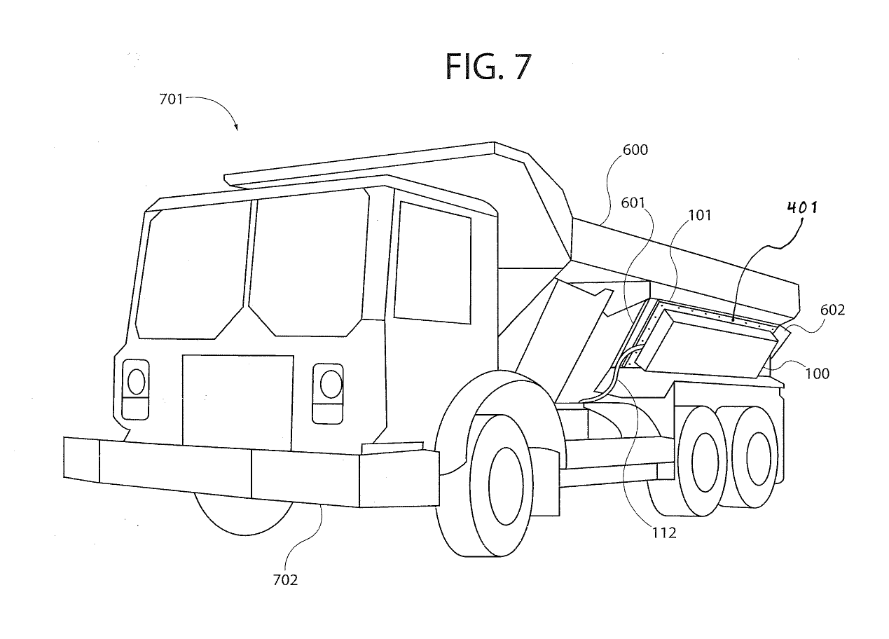

The cover 110 may have any suitable shape, and may be rectilinear, curvilinear, or combination thereof. In an embodiment the cover 110 is rectilinear, as shown in FIG. 1. Alternatively, the cover 110 may comprise triangular end portions and rectilinear longitudinal portions to provide a shape configured to fit between an underside of a hopper 600 and a vehicle 702, such as a truck bed as shown in FIG. 7. In an embodiment, the perimeter 106 comprises a first side and an opposite second side, and a first end and an opposite second end. The flange 105 may be disposed on any combination of the first side, the second side, the first end, and the second end. In an embodiment, the flange 105 is disposed on the first side and on the opposite second side of the perimeter 106. In another embodiment, the flange 105 is disposed on the first end and on the opposite second end. In another embodiment, the flange 105 is disposed on the entirety of the perimeter 106 of the cover. In another embodiment, the flange 105 is disposed on a single side and on an adjacent end of the cover. In yet another embodiment the cover may have a spherical shape.

The cover 110 may comprise a side 103 and a top 104, which is disposed on the side 103 to form an enclosure, as shown in FIG. 1. The side 103, the top 104, and the flange 105 of the cover 110 may each individually have any suitable dimensions, and may comprise any suitable material. Representative dimensions include a cover having a length of 1 m to 10 m, a width of 0.5 m to 5 m, and a depth of 5 centimeters (cm) to 50 cm.

The side 103, the top 104, and the flange 105 of the cover 110 may each individually comprise a metal, such as steel, aluminum, iron, copper, tin, or combination thereof, or a polymeric material such as polyethylene, polypropylene, polyurethane, acrylonitrile-butadiene-styrene, polyethylene terephthalate, polyvinyl chloride, polysulfane, or a combination thereof. A combination comprising at least one of the foregoing may be used. In an embodiment, the side may comprise a composite, such as a glass-filled epoxy. Polyethylene is specifically mentioned. The traction control agent freeze preventer may have four sides as shown schematically in FIG. 1. Alternatively, a configuration having a single side, e.g., having a round shape, such as a cylindrical shape, may be used.

The top 104 may be configured based on the dimensions and configuration of the side 103 of the traction control agent freeze preventer. In an embodiment, the top is in the shape of a rectangle, as shown in FIG. 1. In another embodiment the top is in the shape of a disk. The top may be removably connected to the side and/or the base by a fastener, such as a bolt, screw, hook-and-loop fastener, a clasp, a buckle, a strap, or combination thereof. In an embodiment, the top may be hinged.

As shown in FIG. 3, which is a cross-sectional view of the traction control agent freeze preventer 100, the base 101 is adjacent to a heating pad 303. The heating pad is shown in further detail in FIG. 5, which is a cross-sectional bottom view of an embodiment of the traction control agent freeze preventer 100. The heating pad 303 comprises a heating element 501 and optionally a substrate 502. The heating element 501 may be disposed on and optionally connected to the substrate 502. In an embodiment, the substrate may be a woven substrate, and heating element may be disposed in the substrate in a selected pattern, such as a serpentine pattern. A commercially available floor warming mat, such as a Sun Touch floor warming mat, commercially available from Home Depot, Inc., can be used.

As is also shown in FIG. 3, in an embodiment, a first layer of insulation 301 and a second layer of insulation 302 may be disposed between the cover 110 and the heating pad 303. Any suitable number of layers of insulation may be used, such as 1 to 10 layers, or 2 to 6 layers. In a preferred embodiment, two layers of insulation may be used. The thermal resistance (“R-value”) of each layer of insulation individually may be 4 to 80, 6 to 40, or 8 to 30. An R-value of 36 is specifically mentioned.

Any suitable type of insulation may be used. Representative insulation types include fiberglass, polyurethane, polystyrene, polyisocyanurate, wool, paper, cellulous, or a combination thereof. In an embodiment, each layer of insulation may comprise the same material or combination of materials. As is also shown in FIG. 3, in a preferred embodiment a first layer of insulation comprises a fibrous insulation, and a second layer of insulation comprises a foam insulation. In a preferred embodiment, the first layer of insulation is fiberglass, and the second layer is polystyrene.

As shown in FIG. 1, the temperature controller 120 may be connected to a power source 121, such as a battery of a vehicle, and is also connected to the heating pad by a control cable 112. Any suitable temperature controller may be used. For example, a SUNTOUCH Floor Warming control, available from Home Depot, Inc., may be used.

As is also shown in FIG. 1, in an embodiment in which the temperature controller is configured to use alternating current and the vehicle provides direct current, an inverter may be used to convert the power from the vehicle to alternating current for use by the temperature controller. Alternatively, if the power from the vehicle is compatible with the temperature controller the inverter may be omitted. In an embodiment in which the inverter is used, the temperature controller 120 may be connected to an inverter 122 by an inverter cable 124, and the inverter 122 may then be connected to a power source 121, such as a battery, by a power cable 123.

The power source may have any suitable voltage. In an embodiment in which the power source provides direct current, the voltage of the power source may be 6 Volts (V) to 48 V, 12 V to 36 V, or 24 V. A 12 V or 48 V power source is specifically mentioned. The power source 121 may be a battery, such as a truck battery, or may be a generator, such as an alternator of a truck, or a gas powered generator, for example. Alternatively, an alternating current power source may be used, and a voltage of the alternating current power source maybe 100 V to 130 V, or 200 V to 230 V. In an embodiment, a generator, such as a gas generator, may be used. Use of an alternator connected to the vehicle engine is specifically mentioned.

The length the cable 112 between the temperature controller and the heating pad may be selected so that the temperature controller may be provided in a cab of the vehicle, such as a cab of a truck on which the traction control agent freeze preventer is disposed, thereby allowing an operator to control the temperature of the heating pad, and in turn the temperature of the traction control agent in the traction control agent freeze preventer from within the cab of the vehicle.

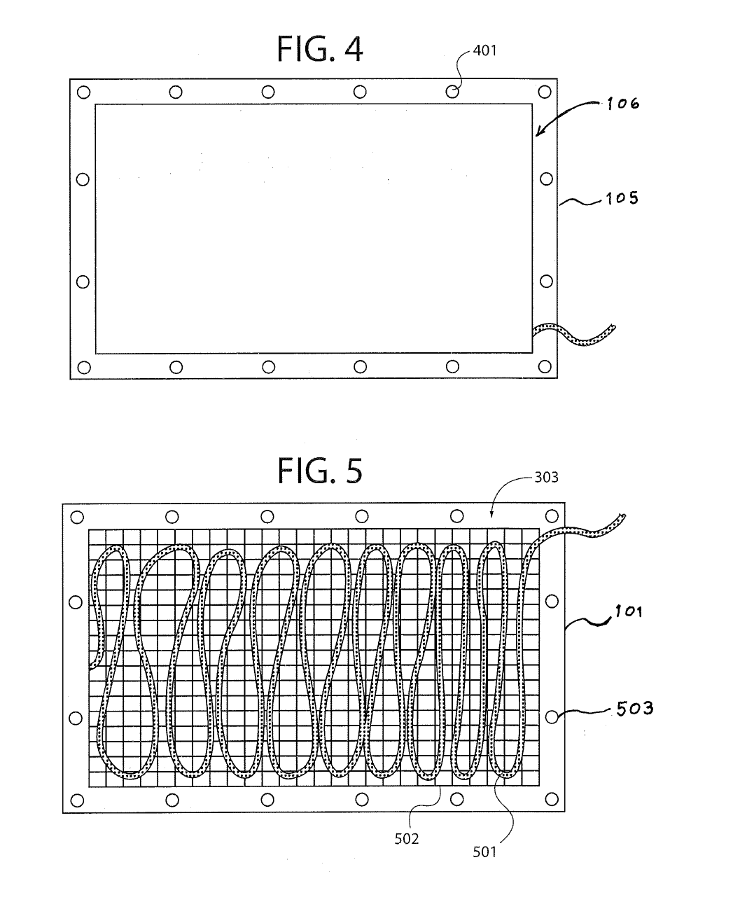

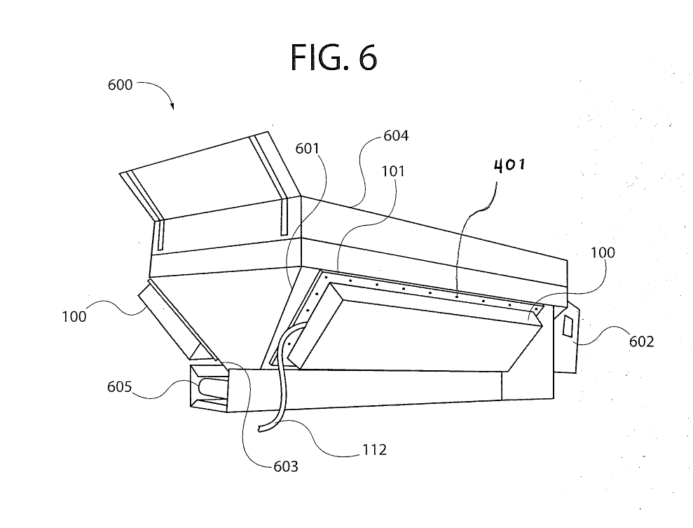

Also disclosed is a traction control agent dispenser comprising the traction control agent freeze preventer 100 disposed on a hopper 600, which is configured to contain traction control agent. As shown in FIG. 6, in an embodiment the traction control agent freeze preventer 100 is disposed on an underside 601 of the hopper 600. In this configuration, the base 101 comprising the heating pad 303 is adjacent to and may contact the underside 601 of the hopper 600. In an embodiment, the base 101 comprising the heating pad 303 may be affixed to the underside 601 of the hopper 600. In an embodiment, the base 101 may be affixed to the underside 601 of the hopper 600 using an adhesive. Alternatively, the base 101 comprising the heating pad 303 may be affixed to the underside 601 of the hopper 600 by welding the base 101 to the underside 601 of the hopper 600. In an embodiment shown in FIG. 4, the flange 105 on the perimeter 106 of the cover 110 may comprise a cover opening 401, as is shown in FIG. 4. In an embodiment shown in FIG. 5, the base 101 of the traction control agent freeze preventer may comprise a base opening 503. In an embodiment, the cover opening 401 may be aligned with the base opening 503 so that a fastener may be disposed through both the cover opening 401 and the base opening 503. In an embodiment shown in FIG. 6, the traction control agent freeze preventer 100 may be disposed on the underside 601 of the hopper 600 using a fastener disposed through the cover opening 401 and the base opening 503. Any suitable fastener may be used. Representative fasteners include screws, rivets, and bolts. In an embodiment, the traction control agent freeze preventer is bolted to the underside 601 of the hopper 600.

The hopper 600 may comprise a funnel shape, as shown in FIG. 6, which funnel shape has a top end 604 and an opposite, bottom end 603 wherein the bottom end 603 is narrower in proportion to the widest part of the hopper 600. In an embodiment, the hopper may comprise an outlet for release of the traction control agent. In an embodiment, the bottom end 603 comprises an outlet configured to release traction control agent. In an embodiment, the hopper 600 comprises a spreader 602 disposed on the hopper, which spreader 602 is capable of dispersing the traction control agent. In an embodiment, the hopper 600 comprises a conveyer 605 beneath an opening in the bottom end 603 of the hopper 600, wherein the outlet is configured to release traction control agent to the spreader 602. In an embodiment, the hopper 600 comprises a raised underside, and wherein the traction control agent freeze preventer is disposed on the raised underside such that the traction control agent dispenser is between the underside of the hopper and a vehicle.

Also disclosed is a vehicle 701, which comprises the traction control agent dispenser 600, disposed on a vehicle 702. FIG. 7 shows an embodiment of the vehicle, wherein the traction control agent freeze preventer is mounted on an underside of a hopper, wherein the hopper is disposed on a vehicle. Any suitable vehicle 702 may be used. In an embodiment the vehicle 702 is a truck.

Also disclosed is a method of treating traction control agent. The method comprises disposing a traction control agent in a traction control agent dispenser 600, as shown in FIG. 6, and actuating the traction control agent freeze preventer 100 to heat the traction control agent to treat the traction control agent. In an embodiment, the heating comprises heating an underside 601 of the hopper 600 by contacting the underside of the hopper with the base 101 of the traction control agent freeze preventer 100 comprising the heating pad 303 and providing power to the heating pad 303.

Also disclosed is method of road maintenance. The method comprises disposing traction control agent in a traction control agent dispenser 600, actuating the traction control agent freeze preventer to heat the traction control agent, and then dispensing the traction control agent on a surface on which application of the traction control agent is desired. The method of road maintenance may comprise treating a roadway, a sidewalk, or any other desired surface.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross-sectional illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

What is claimed is:

1. A traction control agent freeze preventer comprising:
a base comprising a metal;
a cover, which is disposed on the base, wherein the cover comprises a flange disposed adjacent to the base and on a perimeter of the cover;
a heating pad disposed adjacent to the base and between the cover and the base;
an insulation layer disposed between the heating pad and the cover and opposite the base; wherein the insulation layer and the heating pad are entirely contained between the base and the cover; and
a temperature controller, which is connected to the heating pad and configured to control a temperature of the heating pad.

2. The traction control agent freeze preventer of claim 1, wherein the metal of the base comprises steel, aluminum, iron, copper, tin, or combination thereof.

3. The traction control agent freeze preventer of claim 1, wherein the perimeter comprises a first side and an opposite second side, and a first end and an opposite second end, and wherein the flange is disposed on the first side and on the opposite second side of the perimeter.

4. The traction control agent freeze preventer of claim 1, wherein the cover comprises polymeric material.

5. The traction control agent freeze preventer of claim 4, wherein the polymeric material of the cover comprises polyethylene, polystyrene, polycarbonate, polypropylene, acrylonitrile-butadiene-styrene, polyethylene terephthalate, polyvinyl chloride, polysulfane, or a combination thereof.

6. The traction control agent freeze preventer of claim 1, wherein the insulation layer comprises fiberglass, polyurethane, polystyrene, polyisocyanurate, wool, paper, cellulose, or a combination thereof.

7. The traction control agent freeze preventer of claim 1, wherein the insulation layer comprises a first layer and a second layer, the first layer comprising a fibrous insulation and the second layer comprising a foam insulation.

8. The traction control agent freeze preventer of claim 7, wherein the first layer of insulation is fiberglass, and the second layer is polystyrene.

9. The traction control agent freeze preventer of claim 1, wherein the temperature controller is configured to use an alternating current voltage of 100 volts to 130 volts.

10. The traction control agent freeze preventer of claim 1, further comprising an inverter, which is connected to the controller.

11. A traction control agent dispenser comprising:
a hopper; and
a traction control agent freeze preventer on the hopper, the traction control agent freeze preventer comprising:
a base comprising a metal,
a cover, which is disposed on the base, wherein the cover comprises a flange disposed adjacent to the base and on a perimeter of the cover,
a heating pad disposed adjacent to the base and between the cover and the base;
an insulation layer disposed between the heating pad and the cover and opposite the base, wherein the insulation layer and the heating pad are entirely contained between the base and the cover, and
a temperature controller, which is connected to the heating pad and configured to control a temperature of the heating pad.

12. The traction control agent dispenser of claim 11, wherein the traction control agent freeze preventer is affixed to an underside surface of the hopper.

13. The traction control agent dispenser of claim 11, wherein the hopper comprises a raised underside, and wherein the traction control agent freeze preventer is disposed on the raised underside such that the traction control agent freeze preventer is between the underside of the hopper and a vehicle.

14. A road maintenance vehicle comprising a vehicle and the traction control agent dispenser of claim 11 disposed on the vehicle.

15. A method of treating a traction control agent, the method comprising:
providing a traction control agent dispenser, the traction control agent dispenser comprising
a hopper, and
a traction control agent freeze preventer on the hopper, the traction control agent freeze preventer comprising
a base comprising a metal,
a cover, which is disposed on the base, wherein the cover comprises a flange disposed adjacent to the base and on a perimeter of the cover,
a heating pad disposed adjacent to the base and between the cover and the base,
an insulation layer disposed between the heating pad and the cover and opposite the base, wherein the insulation layer and the heating pad are entirely contained between the base and the cover, and
a temperature controller, which is connected to the heating pad and configured to control a temperature of the heating pad;
disposing a traction control agent in the traction control agent dispenser; and
actuating the traction control agent freeze preventer to heat the traction control agent to treat the traction control agent.

16. A method of road maintenance, the method comprising:
providing a vehicle comprising a traction control agent dispenser, the traction control agent dispenser comprising
a hopper, and
a traction control agent freeze preventer of on the hopper, the traction control agent freeze preventer comprising
a base comprising a metal;
a cover, which is disposed on the base, wherein the cover comprises a flange disposed adjacent to the base and on a perimeter of the cover;
a heating pad disposed adjacent to the base and between the cover and the base;
an insulation layer disposed between the heating pad and the cover and opposite the base, wherein the insulation layer and the heating pad are entirely contained between the base and the cover; and
a temperature controller, which is connected to the heating pad and configured to control a temperature of the heating pad;
disposing a traction control agent in the traction control agent dispenser;
actuating the traction control agent freeze preventer to heat the traction control agent; and
dispensing the traction control agent to perform road maintenance.

17. A traction control agent dispenser comprising:
a hopper; and
a traction control agent freeze preventer on the hopper, the traction control agent freeze preventer comprising
a base, which comprises aluminum,
a cover, which is disposed on the base, wherein the cover comprises polypropylene, polyethylene, or a combination thereof, wherein the cover has a first side and an opposite second side, and a first end and an opposite second end,
a flange disposed adjacent to the base and on the first side and on the second side of the perimeter of the cover,
a heating pad disposed adjacent to the base and between the cover and the base,
an insulation layer adjacent to the heating pad and opposite the base, wherein the insulation layer is disposed between the heating pad and the cover, wherein the insulation layer and the heating pad are entirely contained between the base and the cover, wherein the insulation layer comprises a first layer and a second layer, wherein the first layer comprises fiberglass and the second layer comprises polystyrene, and
a temperature controller, which is connected to the heating pad and configured to control a temperature of the heating pad, and
n inverter, which is connected to the temperature controller.
